(19) United States
(12) Patent Application Publication
(10) Pub. No.: US 2008/0229058 A1
(43) Pub. Date: Sep. 18, 2008

(54) Configurable Microprocessor

(76) Inventors: Hung Qui Le, Austin, TX (US); Dung Quoc Nguyen, Austin, TX (US); Balaram Sinharoy, Poughkeepsie, NY (US)

Correspondence Address: IBM CORP (YA);C/O YEE & ASSOCIATES PC, P.O. BOX 802333, DALLAS, TX, 75380, US

(21) Appl. No.: 11/685,422

(22) Filed: Mar. 13, 2007

(51) Int. Cl. G06F 15/76

(52) U.S. Cl. 712/13

(57) ABSTRACT

A configurable microprocessor that handles low computing-intensive workloads by partitioning a single processor core into two smaller corelets. The process partitions resources of a single microprocessor core to form a plurality of corelets and assigns a set of the partitioned resources to each corelet. Each set of partitioned resources is dedicated to one corelet to allow each corelet to function independently of other corelets in the plurality of corelets. The process also combines a plurality of corelets into a single microprocessor core by combining corelet resources to form a single microprocessor core. The combined resources feed the single microprocessor core.

### BACKGROUND

1. Field of the Invention

The present invention relates generally to an improved data processing system and in particular to a method and apparatus for processing data. Still more particularly, the invention relates to a configurable microprocessor that handles low computing-intensive workloads by partitioning a single processor core into multiple smaller corelets, and handles high computing-intensive workloads by combining a plurality of corelets into a single microprocessor core when needed.

2. Description of the Related Art

In microprocessor design, efficient use of silicon becomes critical as power consumption increases when one adds more functions to the microprocessor design to increase performance. One way of increasing performance of a microprocessor is to increase the number of processor cores fitted on the same processor chip. For example, a single processor chip needs only one processor core. In contrast, a dual processor core chip needs a duplicate of the processor core on the chip. Normally, one designs each processor core to be able to provide high performance individually. However, to enable each processor core on a chip to handle high performance workloads, each processor core requires a lot of hardware resources. In other words, each processor core requires a large amount of silicon. Thus, the number of processor cores added to a chip to increase performance can increase power consumption significantly, regardless of the types of workloads (e.g., high computing-intensive workloads, low computing-intensive workloads) that each processor core on the chip is running individually. If both processor cores on a chip are running low performance workloads, then the extra silicon provided to handle high performance is wasted and burns power needlessly.

### SUMMARY

The illustrative embodiments provide a configurable microprocessor that handles low computing-intensive workloads by partitioning a single processor core into two smaller corelets. The process employs corelets to handle low computing-intensive workloads by partitioning resources of a single microprocessor core to form partitioned resources, wherein each partitioned resource comprises a smaller amount of a non-partitioned resource in the single microprocessor core. The process may then form a plurality of corelets from the single microprocessor core by assigning a set of partitioned resources to each corelet in the plurality of corelets, wherein each set of partitioned resources is dedicated to one corelet to allow each corelet to function independently of other corelets in the plurality of corelets, and wherein each corelet processes instructions with its dedicated set of partitioned resources.

### BRIEF DESCRIPTION OF THE DRAWINGS

The novel features believed characteristic of the illustrative embodiments are set forth in the appended claims. The illustrative embodiments themselves, however, as well as a preferred mode of use, further objectives and advantages thereof, will best be understood by reference to the following detailed description of the illustrative embodiments when read in conjunction with the accompanying drawings, wherein:

FIG. 1 depicts a pictorial representation of a computing system in which the illustrative embodiments may be implemented;

FIG. 2 is a block diagram of a data processing system in which the illustrative embodiments may be implemented;

FIG. 3 is a block diagram of a partitioned processor core, or corelet, in accordance with the illustrative embodiments;

FIG. 4 is a block diagram of an exemplary combination of two corelets on the same microprocessor which form a supercore in accordance with the illustrative embodiments;

FIG. 5 is a block diagram of an alternative exemplary combination of two corelets on the same microprocessor forming a supercore in accordance with the illustrative embodiments;

FIG. 6 is a flowchart of an exemplary process for partitioning a configurable microprocessor into corelets in accordance with the illustrative embodiments;

FIG. 7 is a flowchart of an exemplary process for combining corelets in a configurable microprocessor into a supercore in accordance with the illustrative embodiments; and

FIG. 8 is a flowchart of an alternative exemplary process for combining corelets in a configurable microprocessor into a supercore in accordance with the illustrative embodiments.

### DETAILED DESCRIPTION OF THE PREFERRED EMBODIMENT

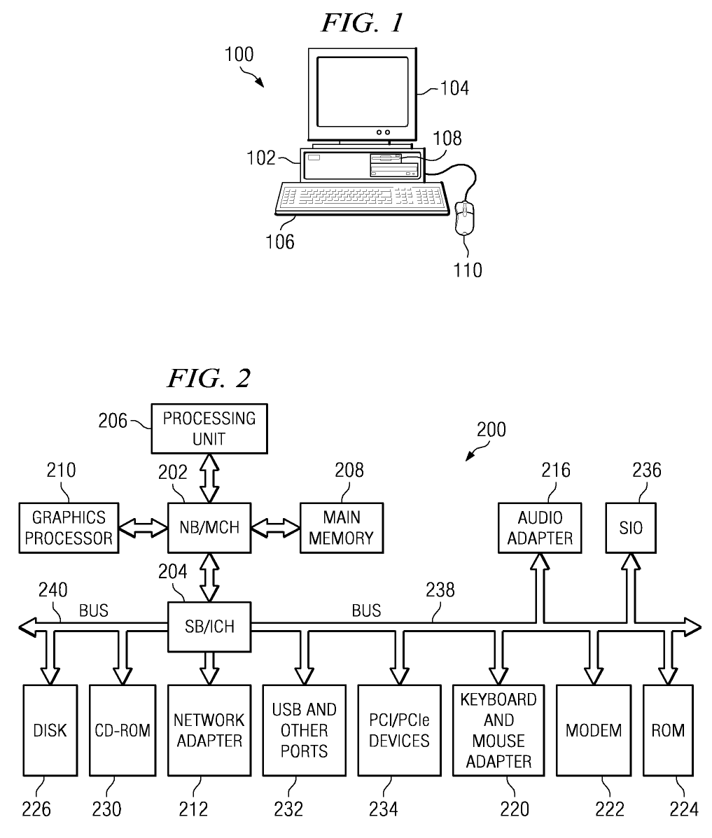

With reference now to the figures and in particular with reference to FIG. 1, a pictorial representation of a data processing system is shown in which the illustrative embodiments may be implemented. Computer 100 includes system unit 102, video display terminal 104, keyboard 106, storage devices 108, which may include floppy drives and other types of permanent and removable storage media, and mouse 110. Additional input devices may be included with personal computer 100. Examples of additional input devices include a joystick, touchpad, touch screen, trackball, microphone, and the like.

Computer 100 may be any suitable computer, such as an IBM® eServer™ computer or IntelliStation® computer, which are products of International Business Machines Corporation, located in Armonk, N.Y. Although the depicted representation shows a personal computer, other embodiments may be implemented in other types of data processing systems. For example, other embodiments may be implemented in a network computer. Computer 100 also preferably includes a graphical user interface (GUI) that may be implemented by means of systems software residing in computer readable media in operation within computer 100.

Next, FIG. 2 depicts a block diagram of a data processing system in which the illustrative embodiments may be implemented. Data processing system 200 is an example of a computer, such as computer 100 in FIG. 1, in which code or instructions implementing the processes of the illustrative embodiments may be located.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204, audio adapter 216, keyboard and mouse adapter 220, modem 222, read only memory (ROM) 224, universal serial bus (USB) ports, and other communications ports 232. PCI/PCIe devices 234 are coupled to south bridge and I/O controller hub 204 through bus 238. Hard disk drive (HDD) 226 and CD-ROM drive 230 are coupled to south bridge and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206. This operating system coordinates and controls various components within data processing system 200 in FIG. 2. The operating system may be a commercially available operating system, such as Microsoft® Windows XP®. (Microsoft® and Windows XP® are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java-based trademarks are trademarks of Sun Microsystems, Inc. in the United States, other countries, or both.

Instructions for the operating system, the object-oriented programming system, and applications or programs are located on storage devices, such as hard disk drive 226. These instructions and may be loaded into main memory 208 for execution by processing unit 206. The processes of the illustrative embodiments may be performed by processing unit 206 using computer implemented instructions, which may be located in a memory. An example of a memory is main memory 208, read only memory 224, or in one or more peripheral devices.

The hardware shown in FIG. 1 and FIG. 2 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1 and FIG. 2. Additionally, the processes of the illustrative embodiments may be applied to a multiprocessor data processing system.

The systems and components shown in FIG. 2 can be varied from the illustrative examples shown. In some illustrative examples, data processing system 200 may be a personal digital assistant (PDA). A personal digital assistant generally is configured with flash memory to provide a non-volatile memory for storing operating system files and/or user-generated data. Additionally, data processing system 200 can be a tablet computer, laptop computer, or telephone device.

Other components shown in FIG. 2 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture. Additionally, a communications unit may include one or more devices used to transmit and receive data, such as a modem or a network adapter. Further, a memory may be, for example, main memory 208 or a cache such as found in north bridge and memory controller hub 202. Also, a processing unit may include one or more processors or CPUs.

The depicted examples in FIG. 1 and FIG. 2 are not meant to imply architectural limitations. In addition, the illustrative embodiments provide for a computer implemented method, apparatus, and computer usable program code for compiling source code and for executing code. The methods described with respect to the depicted embodiments may be performed in a data processing system, such as data processing system 100 shown in FIG. 1 or data processing system 200 shown in FIG. 2.

The illustrative embodiments provide a configurable single processor core which handles low computing-intensive workloads by partitioning the single processor core. In particular, the illustrative embodiments partition the configurable processor core into two or more smaller cores, called corelets, to provide the processor software with two dedicated smaller cores to independently handle low performance workloads. When the microprocessor requires higher performance, the software may combine the individual corelets into a single core, called a supercore, to allow for handling high computing-intensive workloads.

The configurable microprocessor in the illustrative embodiments provides the processing software with a flexible means of controlling the processor resources. In addition, the configurable microprocessor assists the processing software in scheduling the workloads more efficiently. For example, the processing software may schedule several low computing-intensive workloads in corelet mode. Alternatively, to significantly increase processing performance, the processing software may schedule a high computing-intensive workload in supercore mode, in which all resources in the microprocessor are available to the single workload.

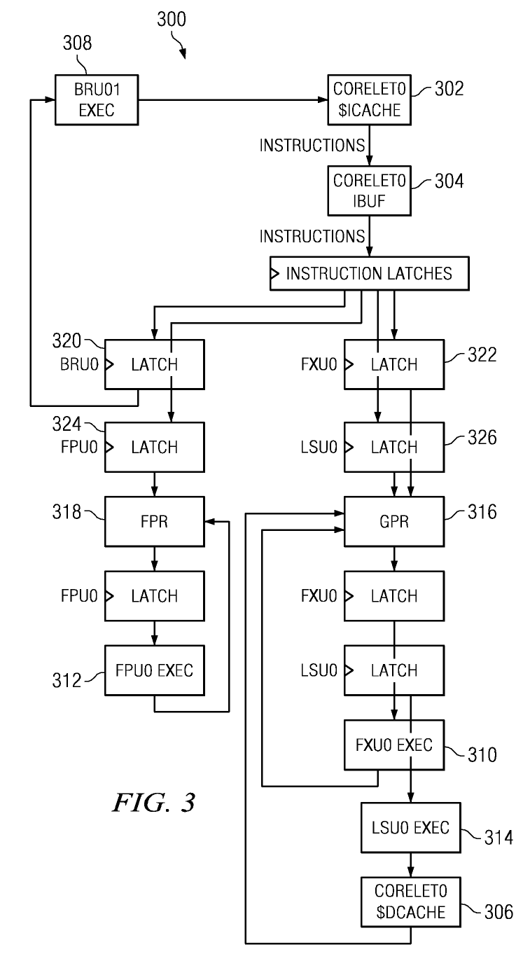

FIG. 3 is a block diagram of a partitioned processor core, or corelet, in accordance with the illustrative embodiments. Corelet 300 may be implemented as processing unit 202 in FIG. 2 in these illustrative examples, and may also operate according to reduced instruction set computer (RISC) techniques.

Corelet 300 comprises various units, registers, buffers, memories, and other sections, all of which are formed by integrated circuitry. The creation of corelet 300 occurs when the processor software sets a bit to partition a single microprocessor core into two or more corelets to allow the corelets to handle low performance workloads. The two or more corelets function independently of each other. Each corelet created will contain the resources that were available to the single microprocessor core (e.g., data cache (DCache), instruction cache (ICache), instruction buffer (IBUF), link/count stack, completion table, etc.), although the size of each resource in each corelet will be a portion of the size of the resource in the single microprocessor core. Creating corelets from a single microprocessor core also includes partitioning all other non-architected resources of the microprocessor, such as renames, instruction queues, and load/store queues, into smaller quantities. For example, if the single microprocessor core is split into two corelets, one-half of each resource may support one corelet, while the other half of each resource may support the other corelet. It should also be noted that the illustrative embodiments may partition the resources unequally, such that a corelet requiring higher processing performance may be provided with more resources than other corelet(s) in the same microprocessor.

Corelet 300 is an example of one of a plurality of corelets created from a single microprocessor core. In this illustrative example, corelet 300 comprises instruction cache (ICache) 302, instruction buffer (IBUF) 304, and data cache (DCache) 306. Corelet 300 also contains multiple execution units, including branch unit (BRU0) 308, fixed point unit (FXU0) 310, floating point unit (FPU0) 312, and load/store unit (LSU0) 314. Corelet 300 also comprises general purpose register (GPR) 316 and floating point register (FPR) 318. As previously mentioned, since each corelet in the same microprocessor may function independently from each other, resources 302-318 in corelet 300 are dedicated solely to corelet 300.

Instruction cache 302 holds instructions for multiple programs (threads) for execution. These instructions in corelet 300 are processed and completed independently of other corelets in the same microprocessor. Instruction cache 302 outputs the instructions to instruction buffer 304. Instruction buffer 304 stores the instructions so that the next instruction is available as soon as the processor is ready. A dispatch unit (not shown) may dispatch the instructions to the respective execution unit. For example, corelet 300 may dispatch instructions to branch unit (BRU0 Exec) 308 via BRU0 latch 320, to fixed point unit (FXU0 Exec) 310 via FXU0 latch 322, to floating point unit (FPU0 Exec) 312 via FPU0 latch 324, and to load/store unit (LSU0 Exec) 314 via LSU0 latch 326.

Execution units 308-314 execute one or more instructions of a particular class of instructions. For example, fixed point unit 310 executes fixed-point mathematical operations on register source operands, such as addition, subtraction, ANDing, ORing and XORing. Floating point unit 312 executes floating-point mathematical operations on register source operands, such as floating-point multiplication and division. Load/Store unit 314 executes load and store instructions which move data into different memory locations. Load/Store unit 314 may access its own DCache 306 partition to obtain load/store data. Branch unit 308 executes its own branch instructions which conditionally alter the flow of execution through a program, and fetches its own instruction stream from instruction buffer 304.

GPR 316 and FPR 318 are storage areas for data used by the different execution units to complete requested tasks. The data stored in these registers may come from various sources, such as a data cache, memory unit, or some other unit within the processor core. These registers provide quick and efficient retrieval of data for the different execution units within corelet 300.

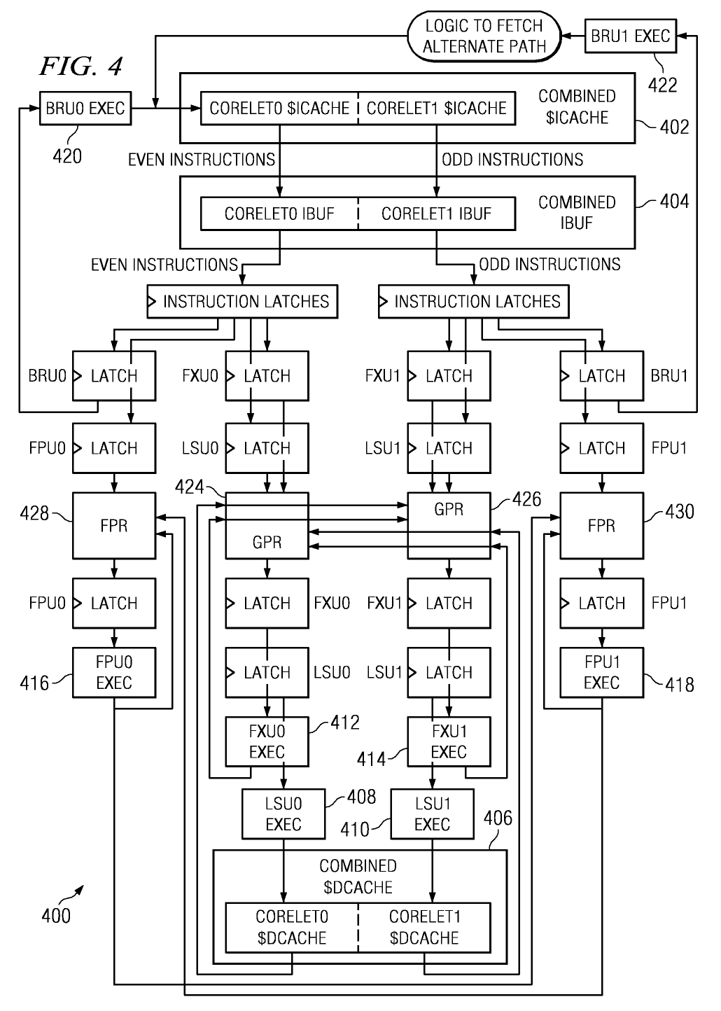

FIG. 4 is a block diagram of an exemplary combination of two corelets on the same microprocessor to form a supercore in accordance with the illustrative embodiments. Supercore 400 may be implemented as processing unit 202 in FIG. 2 in these illustrative examples and may operate according to reduced instruction set computer (RISC) techniques.

The creation of a supercore may occur when the processor software sets a bit to combine two or more corelets into a single core, or supercore, to allow for handling high computing-intensive workloads. The process may include combining all of the available corelets or only a portion of the available corelets in the microprocessor. Combining the corelets includes combining the instruction caches from the individual corelets to form a larger combined instruction cache, combining the data caches from the individual corelets to form a larger combined data cache, and combining the instruction buffers from the individual corelets to form a larger combined instruction buffer. All other non-architected hardware resources such as instruction queues, rename resources, load/store queues, link/count stacks, and completion tables also combine into larger resources to feed the supercore. While this illustrative embodiment recombines the instruction caches, instruction buffers, and data caches of the corelets to allow the supercore access to a larger amount of resources, the combined instruction cache, combined instruction buffer, and combined data cache still comprise partitions to allow instructions to flow independently of other instructions in the supercore.

In the combination of two corelets as in the illustrated example in FIG. 4, supercore 400 contains a combined instruction cache 402, a combined instruction buffer 404, and a combined data cache 406, which are formed from the instruction caches, instruction buffers, and data caches of the two corelets. As previously shown in FIG. 3, a corelet in a microprocessor may comprise one load/store unit, one fixed point unit, one floating point unit, and one branch unit. By combining two corelets in the microprocessor in this example, the resulting supercore 400 may then include two load/store units 0 408 and 1 410, two fixed point units 0 412 and 1 414, two floating point units 0 416 and 1 418, and two branch units 0 420 and 1 422. In a similar manner, a combination of three corelets into a supercore would allow the supercore to contain three load/store units, three fixed point units, etc.

Supercore 400 dispatches instructions to the two load/store units 0 408 and 1 410, two fixed point units 0 412 and 1 414, two floating point units 0 416 and 1 418, and one branch unit 0 420. Branch unit 0 420 may execute one branch instruction, while the additional branch unit 1 422 may process the alternative branch path of the branch to reduce the branch mispredict penalty. For example, additional branch unit 1 422 may calculate and fetch the alternative branch path, keeping the instructions ready. When a branch mispredict occurs, the fetched instructions are ready to send to combined instruction buffer 404 to resume dispatch.

The two corelets combined in supercore 400 retain most of their individual dataflow characteristics. In this embodiment, supercore 400 dispatches even instructions to the “corelet0” section of combined instruction buffer 404 and dispatches odd instructions to the “corelet1” section of combined instruction buffer 404. Even instructions are instructions 0, 2, 4, 8, etc., as fetched from combined instruction cache 402. Odd instructions are instructions 1, 3, 5, 7, etc., as fetched from combined instruction cache 402. Supercore 400 dispatches even instructions to “corelet0” execution units, which include load/store unit 0 (LSU0 Exec) 408, fixed point unit 0 (FPU0 Exec) 412, floating point unit 0 (FXU0 Exec) 416, and branch unit 0 (BRU0 Exec) 420. Supercore 400 dispatches odd instructions to “corelet1” execution units, which include load/store unit 1 (LSU1 Exec) 410, fixed point unit 1 (FXU1 Exec) 414, floating point unit 1 (FPU1 Exec) 418, and branch unit 1 (BRU1 Exec) 422.

Load/Store units 0 408 and 1 410 may access combined data cache 406 to obtain load/store data. Results from each fixed point unit 0 412 and 1 414, and each load/store unit 0 408 and 1 410 may write to both GPRs 424 and 426. Results from each floating point unit 0 416 and 1 418 may write to both FPRs 428 and 430. Execution units 408-422 may complete instructions using the combined completion facilities of the supercore.

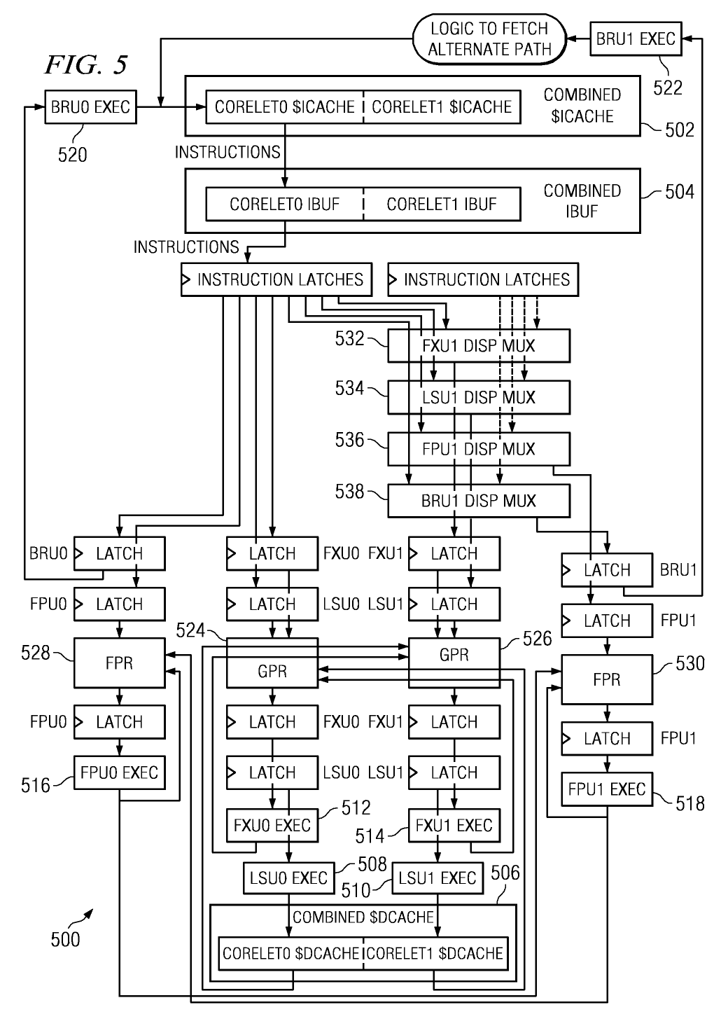

FIG. 5 is a block diagram of an alternative exemplary combination of two corelets on the same microprocessor forming a supercore in accordance with the illustrative embodiments. Supercore 500 may be implemented as processing unit 202 in FIG. 2 in these illustrative examples and may operate according to reduced instruction set computer (RISC) techniques.

The creation of supercore 500 may occur in a manner similar to supercore 400 in FIG. 4. The processor software sets a bit to combine two or more corelets into a single core, and the instruction caches, data caches, and instruction buffers from the individual corelets combine to form a larger combined instruction cache 502, instruction buffer 504, and data cache 506 in supercore 500. Other non-architected hardware resources also combine into larger resources to feed the supercore. However, in this embodiment, the combined instruction cache, combined instruction buffer, and combined data cache are truly combined (i.e., instruction cache, instruction buffer, and data cache do not contain partitions as in FIG. 4), which allows the instructions to be sent sequentially to all execution units in the supercore.

In this illustrative example, the processor software combines two corelets to form supercore 500. Like supercore 400 in FIG. 4, supercore 500 may dispatch instructions to two load/store units 0 (LSU0 Exec) 508 and 1 (LSU1 Exec) 510, two fixed point units 0 (FXU0 Exec) 512 and 1 (FXU1 Exec) 514, two floating point units 0 (FPU0 Exec) 516 and 1 (FPU1 Exec) 518, and one branch unit 0 (BRU0 Exec) 520. Branch unit 0 520 may execute one branch instruction, while additional branch unit 1 (BRU1 Exec) 522 may process the predicted taken path of the branch to reduce the branch mispredict penalty.

In this supercore embodiment, all instructions flow from combined instruction cache 502 through combined instruction buffer 504. Combined instruction buffer 504 stores the instructions in a sequential manner. The instructions are read sequentially from combined instruction buffer 504 and dispatched to all execution units. For instance, supercore 500 dispatches the sequential instructions to execution units 508, 512, 516, and 520 from the one corelet, as well as to execution units 510, 514, 518, and 522 through a set of dispatch muxes, FXU1 dispatch mux 532, LSU1 dispatch mux 534, FPU1 dispatch mux 536, and BRU1 dispatch mux 538. Load/store units 0 508 and 1 510 may access combined data cache 506 to obtain load/store data. Results from each fixed point unit 0 512 and 1 514, and each load/store unit 0 508 and 1 510 may write to both GPRs 524 and 526. Results from each floating point unit 0 516 and 1 518 may write to both FPRs 528 and 530. All execution units 508-522 may complete the instructions using the combined completion facilities of the supercore.

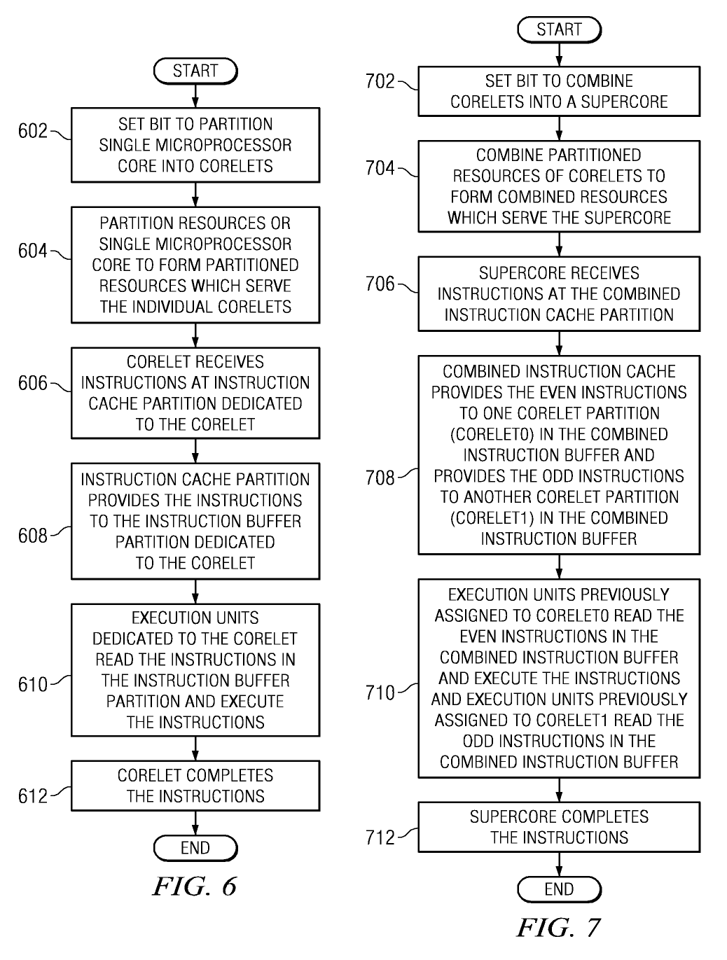

FIG. 6 is a flowchart of an exemplary process for partitioning a configurable microprocessor into corelets in accordance with the illustrative embodiments. The process begins with the processor software setting a bit to partition a single microprocessor core into two or more corelets (step 602). To form the corelets, the process partitions the resources of the microprocessor core (architected and non-architected) to form partitioned resources which serve the individual corelets (step 604). Consequently, each corelet functions independently of the other corelets, and each partitioned resource assigned to each corelet is a portion of the resource of the single microprocessor core. For example, each corelet has a smaller data cache, instruction cache, and instruction buffer than the single microprocessor. The partitioning process also partitions non-architected resources such as rename resources, instruction queues, load/store queues, link/count stacks, and completion tables into smaller resources for each corelet. The process of assigning partitioned resources to a corelet dedicates those resources to that particular corelet only.

Once the corelets are formed, each corelet operates by receiving instructions in the instruction cache partition dedicated to the corelet (step 606). The instruction cache provides the instructions to the instruction buffer partition dedicated to the corelet (step 608). Execution units dedicated to the corelet read the instructions in the instruction buffer and execute the instructions (step 610). For instance, each corelet may dispatch instructions to the load/store unit partition, fixed point unit partition, floating point unit partition, or branch unit partition dedicated to the corelet. Also, a branch unit partition may execute its own branch instructions and fetch its own instruction stream. A load/store unit partition may access its own data cache partition for its load/store data. After executing an instruction, the corelet completes the instruction (step 612), with the process terminating thereafter.

FIG. 7 is a flowchart of an exemplary process for combining corelets in a configurable microprocessor into a supercore in accordance with the illustrative embodiments. The process begins with the processor software setting a bit to combine two or more corelets into a supercore (step 702). To form the supercore, the process combines the partitioned resources of selected corelets to form combined (and larger) resources which serve the supercore (step 704). For example, the process combines the instruction cache partitions of each of the corelets to form a combined instruction cache, the data cache partitions of each of the corelets to form a combined data cache, and the instruction buffer partitions of each of the corelets to form a combined instruction buffer. The combining process also combines all other non-architected hardware resources such as instruction queues, rename resources, load/store queues, and link/count stacks into larger resources to feed the supercore.

Once the supercore is formed, the supercore operates by receiving instructions in the combined instruction cache partition (step 706). The instruction cache provides the even instructions (e.g., 0, 2, 4, 6, etc.) to one corelet partition (e.g., “corelet0”) in the combined instruction buffer, and provides the odd instructions (e.g., 1, 3, 5, 7, etc.) to one corelet partition (“corelet1”) in the combined instruction buffer (step 708). Execution units (e.g., LSU0, FXU0, FPU0, or BRU0) previously assigned to corelet0 read the even instructions from the combined instruction buffer and execute the instructions, and execution units (e.g., LSU1, FXU1, FPU1, or BRU1) previously assigned to corelet1 read the odd instructions from the combined instruction buffer (step 710). One branch unit (e.g., BRU0) may execute one branch instruction, while the other branch unit (BRU1) may be used to process the alternative branch path of the branch to reduce branch mispredict penalty. Within the supercore, each load/store unit may access the combined data cache to obtain load/store data, and the load/store units and fixed point units may write their results to both GPRs. Each floating point unit may write to both FPRs. After executing the instructions, the supercore completes the instructions using combined completion facilities (step 712), with the process terminating thereafter.

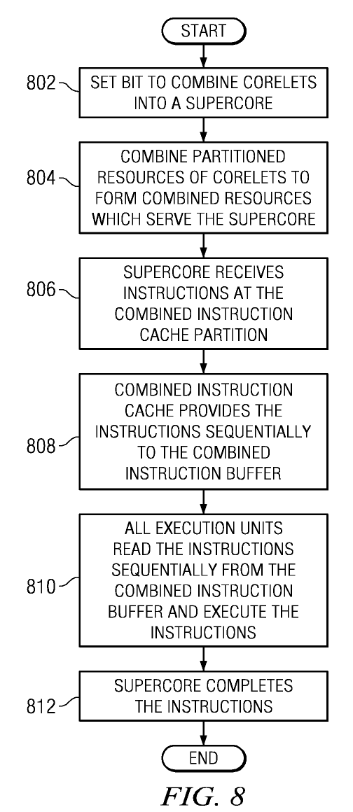

FIG. 8 is a flowchart of an alternative exemplary process for combining corelets in a configurable microprocessor into a supercore in accordance with the illustrative embodiments.

The process begins with the processor software setting a bit to combine two or more corelets into a supercore (step 802). To form the supercore, the process combines the partitioned resources of selected corelets to form combined resources which serve the supercore (step 804). For example, the process combines the instruction cache partitions of each of the corelets to form a combined instruction cache, the data cache partitions of each of the corelets to form a combined data cache, and the instruction buffer partitions of each of the corelets to form a combined instruction buffer. The combining process also combines all other non-architected hardware resources such as instruction queues, rename resources, load/store queues, and link/count stacks into larger resources to feed the supercore.

Once the supercore is formed, the supercore operates by receiving instructions in the combined instruction cache (step 806). The combined instruction cache provides the instructions sequentially to the combined instruction buffer (step 808). All of the execution units (e.g., LSU0, LSU1, FXU0, FXU1, FPU0, FPU1, BRU0, BRU1) read the instructions sequentially from the combined instruction buffer and execute the instructions (step 810). One branch unit (e.g., BRU0) may execute one branch instruction, while the other branch unit (BRU1) may be used to process the alternative branch path of the branch to reduce branch mispredict penalty. Within the supercore, each load/store unit may access the combined data cache to obtain load/store data, and the load/store units and fixed point units may write their results to both GPRs. Each floating point unit may write to both FPRs. After executing the instructions, the supercore completes the instructions using combined completion facilities (step 812), with the process terminating thereafter.

The illustrative embodiments can take the form of an entirely hardware embodiment, an entirely software embodiment or an embodiment containing both hardware and software elements. The illustrative embodiments are implemented in software, which includes but is not limited to firmware, resident software, microcode, etc.

Furthermore, the illustrative embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the illustrative embodiments have been presented for purposes of illustration and description, and is not intended to be exhaustive or limited to the illustrative embodiments in the form disclosed. Many modifications and variations will be apparent to those of ordinary skill in the art. The embodiment was chosen and described in order to best explain the principles of the illustrative embodiments, the practical application, and to enable others of ordinary skill in the art to understand the illustrative embodiments for various embodiments with various modifications as are suited to the particular use contemplated.

What is claimed is:

1. A computer implemented method for partitioning a single microprocessor core into a plurality of corelets, the computer implemented method comprising:
partitioning resources of the single microprocessor core to form partitioned resources, wherein each partitioned resource comprises a portion of a non-partitioned resource in the single microprocessor core; and
forming the plurality of corelets from the single microprocessor core by assigning a set of partitioned resources to each corelet in the plurality of corelets, wherein each set of partitioned resources is dedicated to one corelet to allow each corelet to function independently of other corelets in the plurality of corelets, and wherein each corelet processes instructions with its dedicated set of partitioned resources.

2. The computer implemented method of claim 1, wherein the partitioning step is performed when microprocessor software sets a partition bit to partition the single microprocessor core.

3. The computer implemented method of claim 1, wherein the resources of the single microprocessor core include architected resources and non-architected resources.

4. The computer implemented method of claim 3, wherein the architected resources include a data cache, an instruction cache, and an instruction buffer.

5. The computer implemented method of claim 3, wherein the non-architected resources include rename resources, instruction queues, load/store queues, link/count stacks, and completion tables.

6. The computer implemented method of claim 1, further comprising:
responsive to a corelet in the plurality of corelets receiving the instructions in an instruction cache partition dedicated to the corelet, providing the instructions to an instruction buffer partition dedicated to the corelet;
dispatching the instructions from the instruction buffer partition to execution units dedicated to the corelet;
executing the instructions; and
completing the instructions.

7. The computer implemented method of claim 6, wherein the execution units include a load/store unit partition, fixed point unit partition, floating point unit partition, and branch unit partition dedicated to the corelet.

8. The computer implemented method of claim 7, wherein the branch unit partition in the corelet executes branch instructions and fetches instruction streams which are independent of the other corelets.

9. The computer implemented method of claim 7, wherein the load/store unit partition accesses a data cache partition to obtain load/store data which is independent of the other corelets.

10. The computer implemented method of claim 1, wherein the single microprocessor core is partitioned into a plurality of corelets to handle low computing-intensive workloads.

11. The computer implemented method of claim 1, wherein a portion of a non-partitioned resource in the single microprocessor core is one-half of the non-partitioned resource.

12. A configurable microprocessor, comprising:
a plurality of corelets; and
a set of partitioned resources within each corelet in the plurality of corelets, wherein the set of partitioned resources comprise resources partitioned from a single microprocessor core, and wherein each partitioned resource comprises a portion of a non-partitioned resource in the single microprocessor core;
wherein the plurality of corelets are formed by assigning one set of partitioned resources to each corelet in the plurality of corelets,
wherein each set of partitioned resources is dedicated to one corelet to allow each corelet to function independently of other corelets in the plurality of corelets, and
wherein each corelet processes instructions with its dedicated set of partitioned resources.

13. The configurable microprocessor of claim 12, wherein the resources were partitioned from the single microprocessor core in response to microprocessor software setting a partition bit.

14. The configurable microprocessor of claim 12, wherein the resources partitioned from the single microprocessor core include architected resources and non-architected resources.

15. The configurable microprocessor of claim 14, wherein the architected resources include a data cache, an instruction cache, and an instruction buffer.

16. The configurable microprocessor of claim 14, wherein the non-architected resources include rename resources, instruction queues, load/store queues, link/count stacks, and completion tables.

17. The configurable microprocessor of claim 12, wherein a corelet processes instructions by receiving the instructions in an instruction cache partition dedicated to the corelet, providing the instructions to an instruction buffer partition dedicated to the corelet, dispatching the instructions from the instruction buffer partition to execution units dedicated to the corelet, executing the instructions, and completing the instructions.

18. The configurable microprocessor of claim 12, wherein the single microprocessor core is partitioned into a plurality of corelets to handle low computing-intensive workloads.

19. The configurable microprocessor of claim 12, wherein a portion of a non-partitioned resource in the single microprocessor core is one-half of the non-partitioned resource.

20. An information processing system, comprising:
at least one processing unit comprising a plurality of corelets, wherein each corelet in the plurality of corelets comprise a set of partitioned resources within each corelet, wherein the set of partitioned resources comprise resources partitioned from a single microprocessor core, wherein each set of partitioned resources is dedicated to one corelet to allow each corelet to function independently of other corelets in the plurality of corelets, and wherein each corelet processes instructions with its dedicated set of partitioned resources.
